(19) United States
(12) Patent Application Publication
(10) Pub. No.: US 2026/0270216 A1
(43) Pub. Date: Sep. 10, 2026

(54) DATA PACKET TRANSMISSION METHOD AND RELATED DEVICE

(71) Applicant: TENCENT TECHNOLOGY (SHENZHEN) COMPANY LIMITED, Shenzhen (CN)

(72) Inventor: Zhuoyun ZHANG, Shenzhen (CN)

(73) Assignee: TENCENT TECHNOLOGY (SHENZHEN) COMPANY LIMITED, Shenzhen (CN)

(21) Appl. No.: 19/662,100

(22) Filed: Apr. 29, 2026

Related U.S. Application Data
(63) Continuation of application No. PCT/CN2024/104473, filed on Jul. 9, 2024.

(30) Foreign Application Priority Data
Dec. 7, 2023 (CN) 202311683995.1

(51) Int. Cl. H04L 47/56; H04W 28/02; H04W 28/14; H04W 76/20

(52) U.S. Cl. CPC H04L 47/56; H04W 28/0236; H04W 28/14; H04W 76/20

(57) ABSTRACT

A method, apparatus, and computer-readable storage medium for data packet transmission is provided. The method receiving a data packet. Storage time information of the data packet is determined. The data packet and the storage time information of the data packet is transmitted to a storage function network element. The storage function network element is indicated to store the data packet and the storage time information of the data packet. A transmitting time of the data packet is determined according to the storage time information. The data packet is transmitted to a destination outside a mobile core network at the transmitting time.

### CROSS REFERENCE TO RELATED APPLICATION

This application is a bypass continuation application of International Patent Application No. PCT/CN2024/104473, filed on July 9, 2024, which claims priority to and is based on Chinese Patent Application No. 202311683995.1, filed on December 7, 2023, the disclosures of which are incorporated herein in their entireties by reference.

### FIELD

The present disclosure relates to the field of communication technologies, and in particular, to a data packet transmission method, a communication device, and a computer-readable storage medium.

### BACKGROUND

In a mobile network system, in some scenarios, there are problems of a relatively long transmission delay and limited transmission resources. Consequently, some services of a terminal cannot be responded to on time or even normally.

### SUMMARY

Provided are a data packet transmission method and apparatus, an electronic device, a storage medium, and a program product, which can improve the efficiency and the performance of the data packet transmission.

According to an aspect of some embodiments of the present disclosure, a data packet transmission method performed by a user plane function includes receiving a data packet; determining storage time information of the data packet; transmitting the data packet and the storage time information of the data packet to a storage function network element; indicating the storage function network element to store the data packet and the storage time information of the data packet; determining a transmitting time of the data packet according to the storage time information; and transmitting the data packet to a destination outside the storage function network element at the transmitting time.

According to an aspect of some embodiments of the present disclosure, a communication device includes at least one memory configured to store program code; and at least one processor configured to read the program code and operate as instructed by the program code, the program code including a first receiving code configured to cause the at least one of the at least one processor to receive a data packet; a first determining code configured to cause the at least one of the at least one processor to determine storage time information of the data packet; a first transmitting code configured to cause the at least one of the at least one processor to transmit the data packet and the storage time information of the data packet to a storage function network element; an indicating code configured to cause the at least one of the at least one processor to indicate the storage function network element to store the data packet and the storage time information of the data packet; a second determining code configured to cause the at least one of the at least one processor to determine a transmitting time of the data packet according to the storage time information; and a second transmitting code configured to cause the at least one of the at least one processor to transmit the data packet to a destination outside the storage function network element at the transmitting time.

According to an aspect of some embodiments of the present disclosure, a non-transitory computer-readable storage medium, storing computer code which, when executed by at least one processor, causes the at least one processor to at least receive a data packet; determine storage time information of the data packet; transmit the data packet and the storage time information of the data packet to a storage function network element; indicate the storage function network element to store the data packet and the storage time information of the data packet; determine a transmitting time of the data packet according to the storage time information; and transmit the data packet to a destination outside the storage function network element at the transmitting time.

According to an aspect of some embodiments of the present disclosure, a data packet transmission method performed by a storage function network element in a user plane of a mobile core network includes receiving, from a user plane function, a data packet and storage time information of the data packet; storing the data packet and the storage time information of the data packet; determining a transmitting time of the data packet according to the storage time information; and transmitting the data packet to a destination outside the storage function network element at the transmitting time. A function of the storage function network element is integrated into the user plane function. The determining a transmitting time of the data packet according to the storage time information includes determining, if the storage time information comprises a latest forwarding time of the data packet, the transmitting time of the data packet according to a capacity of the storage function network element and/or a forwarding requirement of a data packet stored in the storage function network element, the transmitting time being earlier than the latest forwarding time; determining, if the storage time information comprises a suggested forwarding time of the data packet, the transmitting time according to the suggested forwarding time; recording, if the storage time information comprises suggested storage duration of the data packet, a receiving time at which the data packet is received from the user plane function, and determining the transmitting time according to the suggested storage duration and the receiving time; and if the storage time information comprises maximum storage duration of the data packet, recording a receiving time of the data packet, and determining the transmitting time according to the maximum storage duration and the receiving time. If the storage function network element is shared by a plurality of user plane functions, the method further includes recording identification information of the user plane function transmitting the data packet; and the transmitting the data packet to a destination outside the mobile core network at the transmitting time includes transmitting, at the transmitting time, the data packet to the user plane function corresponding to the identification information.

According to an aspect of some embodiments of the present disclosure, a data packet transmission method performed by a terminal includes transmitting an uplink data packet to a session management function during establishment of a control plane forwarding path for uplink data transmission, so that the session management function transmits the uplink data packet to a user plane function, wherein the user plane function is configured to receive the uplink data packet; determine storage time information of the uplink data packet; and transmit the uplink data packet and the storage time information of the uplink data packet to a storage function network element. The method further includes transmitting a time parameter of a data packet to the session management function, the time parameter comprising a latest arrival time and/or a maximum value of a transmission delay that are/is of the data packet. The transmitting a time parameter of a data packet to the session management function includes including the time parameter of the data packet in the uplink data packet, and transmitting the uplink data packet to the session management function. The transmitting a time parameter of a data packet to the session management function includes transmitting the time parameter of the data packet to the session management function in a protocol data unit session establishment or update procedure.

According to an aspect of some embodiments of the present disclosure, a data packet transmission method performed by a terminal includes initiating a protocol data unit session establishment or update procedure; transmitting an uplink data packet to a user plane function through a base station, wherein the user plane function is configured to receive the uplink data packet; determining storage time information of the uplink data packet; and transmitting the uplink data packet and the storage time information of the uplink data packet to a storage function network element. The method further includes transmitting a time parameter of a data packet to a session management function in the protocol data unit session establishment or update procedure, the time parameter comprising a latest arrival time and/or a maximum value of a transmission delay that are/is of the data packet. The method further includes when the uplink data packet is transmitted to the user plane function through the base station, the uplink data packet carries the time parameter.

Details of one or more embodiments of the present disclosure are set forth in the accompanying drawings and descriptions below. Other features and advantages of the present disclosure will be apparent from the specification, accompanying drawings, and claims.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a communication system architecture according to an embodiment of the present disclosure.

FIG. 2 is a system architecture diagram of a 5G network according to an embodiment of the present disclosure.

FIG. 3 is a flowchart of a data packet transmission method according to an embodiment of the present disclosure.

FIG. 4 is a schematic interactive diagram of applying a data packet transmission method to an uplink data packet according to an embodiment of the present disclosure.

FIG. 5 is a schematic interactive diagram of applying a data packet transmission method to a downlink data packet according to an embodiment of the present disclosure.

FIG. 6 is a schematic interactive diagram of applying a data packet transmission method to an uplink data packet according to another embodiment of the present disclosure.

FIG. 7 is a schematic interactive diagram of applying a data packet transmission method to a downlink data packet according to another embodiment of the present disclosure.

FIG. 8 is a flowchart of a data packet transmission method according to another embodiment of the present disclosure.

FIG. 9 is a flowchart of a data packet transmission method according to still another embodiment of the present disclosure.

FIG. 10 is a flowchart of a data packet transmission method according to yet another embodiment of the present disclosure.

FIG. 11 is a block diagram of a storage function network element according to an embodiment of the present disclosure.

FIG. 12 is a block diagram of a user plane function according to an embodiment of the present disclosure.

FIG. 13 is a schematic block diagram of a terminal according to an embodiment of the present disclosure.

FIG. 14 is a block diagram of a terminal according to another embodiment of the present disclosure.

FIG. 15 is a schematic structural diagram of a communication device according to an embodiment of the present disclosure.

FIG. 16 is a schematic diagram of an architecture of an integrated system of a 5G network and a satellite system according to an embodiment of the present disclosure.

FIG. 17 is a schematic diagram of an architecture of an integrated system of a 5G network and a satellite system according to another embodiment of the present disclosure.

FIG. 18 is a schematic diagram of an architecture of an integrated system of a 5G network and a satellite system according to yet another embodiment of the present disclosure.

### DETAILED DESCRIPTION

To make the objectives, technical solutions, and advantages of the present disclosure more obvious, example embodiments according to the present disclosure are described in detail below with reference to the accompanying drawings. In the accompanying drawings, same reference signs represent same elements throughout. The embodiments described herein are merely illustrative instead of limiting the scope of the present disclosure. For ease of understanding the technical solutions provided in the present disclosure, related terms are described below.

Terms used in the implementations of this application are merely intended for explaining the embodiments of the present disclosure but not to limit the present disclosure.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

In the embodiments of the present disclosure, term “module” or “unit” refers to a computer program with a predetermined function or a part of the computer program, and works together with other relevant parts to achieve a predetermined objective, and may be all or partially implemented by using a software, a hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The technical solutions in the embodiments of the present disclosure may be applied to various communication systems, for example, a global system of mobile communication (GSM) system, a code division plurality of access (CDMA) system, a wideband code division multiple access (WCDMA) system, a general packet radio service (GPRS), a long term evolution (LTE) system, an LTE frequency division duplex (FDD) system, an LTE time division duplex (TDD), a universal mobile telecommunication system (UMTS), a worldwide interoperability for microwave access (WiMAX) communication system, a 5G system or a future evolved mobile communication system.

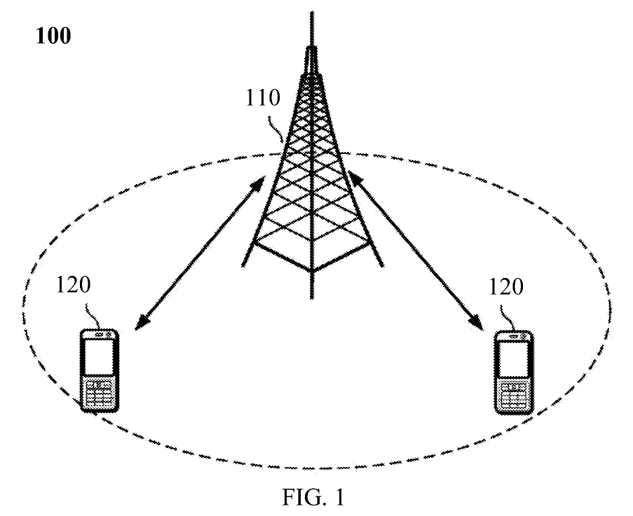

Exemplarily, a communication system 100 to which the embodiments of the present disclosure are applied is shown in FIG. 1. The communication system 100 may include a network device 110, and the network device 110 may be a device that in communication with a terminal 120 (or referred to as a communication terminal or a terminal). The network device 110 may provide communication coverage for a specific geographical area, and may communicate with terminals located in the coverage area. In some embodiments, the network device 110 may be a base transceiver station (BTS) in a GSM system or a CDMA system, may be a NodeB (NB) in a WCDMA system, may be an evolutional NodeB (eNB or eNodeB) in an LTE system, may be a base station in a 5G communication system, or may be a wireless controller in a cloud radio access network (CRAN), or the network device may be a mobile switching center, a relay, an access point, an in-vehicle device, a wearable device, a hub, a switch, a bridge, a router, a network side device in a 5G network, a network side device of a fusion system between a 5G network and a satellite system, a network side device of a 5G system with a new radio satellite access technology, or a network side device of a 5G network that uses satellite transmission as backhaul to a base station. or a network device in a future evolved public land mobile network (PLMN).

The communication system 100 further includes at least one terminal 120 located in coverage of the network device 110. The “terminal” used herein includes, but is not limited to, being connected via a wired line, such as being connected via a public switched telephone network (PSTN), a digital subscriber line (DSL), a digital cable, or a direct cable; and/or another data connection/network; and/or via a wireless interface, for example, for a cellular network, a wireless local area network (WLAN), a digital television network such as a DVB-H network, a satellite network, or an AM-FM broadcast transmitter; and/or an apparatus, configured to receive/transmit a communication signal, and/or another terminal; and/or an Internet of Things (loT) device. A terminal configured to communicate through a wireless interface may be referred to as a “wireless communication terminal”, a “wireless terminal”, or a “mobile terminal”. Examples of the mobile terminal include, but are not limited to, a satellite or a cellular phone; a personal communication system (PCS) terminal that may combine a cellular radio telephone with data processing, facsimile, and data communication capabilities; a personal digital assistant (PDA) that may include a radio telephone, a pager, Internet/intranet access, a web browser, a notepad, a calendar, and/or a global positioning system (GPS) receiver; and a conventional laptop and/or palmtop receiver or other electronic devices including a radio telephone transceiver. The terminal device may refer to an access terminal, a user equipment (UE), a subscriber unit, a subscriber station, a mobile station, a remote station, a remote terminal, a mobile device, a terminal, a wireless communication device, a user agent, or a user apparatus. The access terminal may be a cellular phone, a cordless phone, a session initiation protocol (SIP) phone, a wireless local loop (WLL) station, a PDA, a handheld device having a wireless communication function, a computing device or another processing device connected to a wireless modem, an in-vehicle device, a wearable device, a terminal in a 5G network, a terminal in a future evolved PLMN, or the like.

FIG. 1 exemplarily shows one network device and two terminals. In some embodiments, the communication system 100 may include a plurality of network devices and coverage of each network device may include another quantity of terminals. This is not limited in this embodiment of the present disclosure.

In some embodiments, the communication system 100 may further include other network elements such as a network exposure function (NEF) network element, an application function (AF) network element, and a network function (NF) network element. This is not limited in this embodiment of the present disclosure.

In the embodiments of the present disclosure, a device having a communication function in a network/system may be referred to as a communication device. The communication system 100 shown in FIG. 1 is used as an example. The communication device may include a network device 110 and a terminal 120 that have a communication function. The network device 110 and the terminal 120 may be the specific devices described above, and details are not described herein again.

The terms “system” and “network” in this specification are usually used interchangeably in this specification. In the present disclosure the terms “and/or” are merely an association relationship for describing associated objects and represents that three relationships may exist. For example, A and/or B may represent: only A exists, both A and B exist, and only B exists.

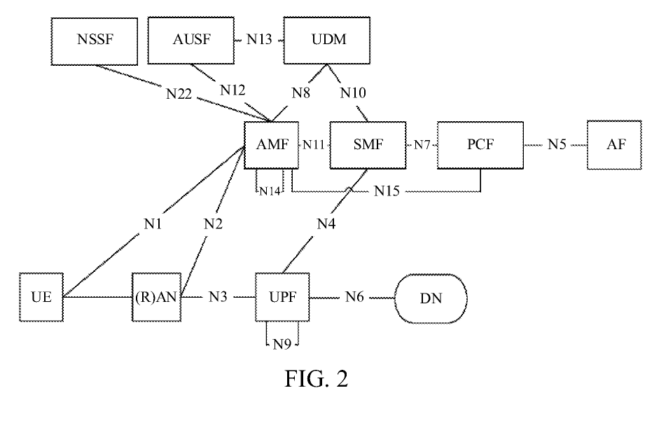

FIG. 2 is a system architecture diagram of a 5G network according to an embodiment of the present disclosure. As shown in FIG. 2, devices involved in the 5G network system include: an user equipment (UE), a radio access network (RAN), an user plane function (UPF) network element, a data network (DN), an access and mobility management Function (AMF) network element, a session management function (SMF) network element, a policy control function (PCF) network element, an application function (AF) network element, an authentication server function (AUSF) network element, and an unified data management (UDM) network element.

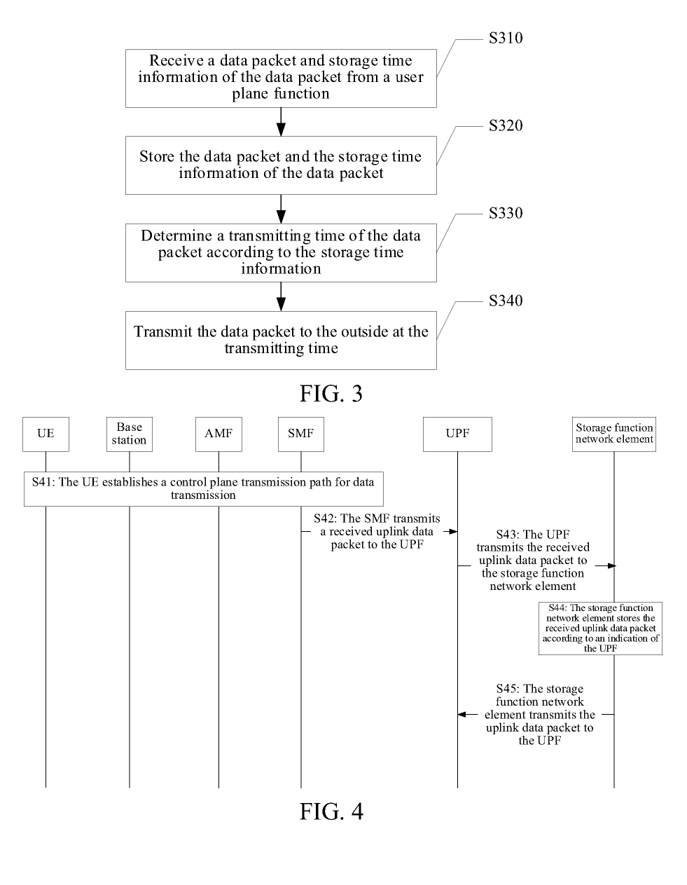

FIG. 3 is a flowchart of a data packet transmission method according to an embodiment of the present disclosure. The method provided in the embodiment of FIG. 3 may be performed by a storage function network element in a user plane of a mobile core network, but the present disclosure is not limited thereto.

In this embodiment of the present disclosure, a SMF may determine, based on parameter information for establishment of a protocol data unit PDU session, whether a store-and-forward operation needs to be performed on the PDU session or a store-and-forward mode is activated, and generate corresponding indication information. The indication information is configured to indicate whether the UPF performs the store-and-forward operation on a data packet in the PDU session or activates the store-and-forward mode.

In some embodiments, a function of the storage function network element is integrated into a user plane function. When the function of the storage function network element is implemented through the UPF, the UPF may further receive the indication information from the SMF. After receiving a data packet, the UPF may determine, according to an indication of the SMF and/or by comprehensively considering a transmission capability, a network status, and the like of the UPF, whether to store the data packet. If the UPF determines to store the data packet, the UPF determines storage time information (which refers to information related to storage duration of the data packet stored in the UPF herein) of the data packet. Then, the data packet is stored into the UPF. For example, the UPF may be divided into a storage function module, and the data packet is stored into the storage function module. The UPF determines, according to the storage time information of the data packet, a transmitting time for transmitting the data packet to a destination outside a storage function network element. When the transmitting time arrives, the UPF transmits the data packet to the destination outside the storage function network element. In some other embodiments, the storage function network element may be another network element independent of the user plane function. In other words, to implement a store-and-forward function, a storage function network element may be newly added to the mobile core network, or a data storage function may be newly added to the user plane function (UPF), that is, a function of the storage function network element is integrated into the UPF.

In this embodiment of the present disclosure, the storage function network element has a data storage and forwarding function, that is, the storage function network element may be configured to store a received data packet and transmit the data packet to the destination outside a storage function network element when a transmitting time arrives. The storage function network element may also be referred to as a data storage function network element or another name being used.

In this embodiment of the present disclosure, the storage function network element/module is a network element/module that is in a network and that is configured to store transmission data sent by a terminal and/or sent to the terminal. A size of a storage space of the storage function network element/module may be set according to an actual requirement, and the size of the storage space of the storage function network element/module is not limited in the present disclosure. Storage duration of a data packet in the storage function network element/module may be determined according to a forwarding requirement of the data packet, a network status, a transmission capability of a network element (for example, the UPF, but the present disclosure is not limited thereto) configured to transmit the data packet in the network, and the like.

As shown in FIG. 3, the method provided in this embodiment of the present disclosure may include the following operations.

S310: Receive a data packet and storage time information of the data packet from the user plane function.

In this embodiment of the present disclosure, the data packet received by the storage function network element from the UPF may be an uplink data packet that a UE prepares to transmit to a service server, and/or a downlink data packet that the service server prepares to transmit to the UE. The data packet may be a service data packet of a target service. The target service may be, for example, an internet of things service having a low delay requirement, or a multimedia service such as augmented reality (AR) or virtual reality (VR). This is not limited in the present disclosure.

In this embodiment of the present disclosure, the data packet received by the storage function network element from the UPF may be a service data packet that is insensitive to a delay. In other words, when receiving a data packet, the UPF may determine, according to indication information received from the session management function (SMF), whether the received data packet needs to be sent to the storage function network element for storage. If the SMF does not indicate, to the UPF by using the indication information, that a store-and-forward operation needs to be performed on a PDU session in which the data packet is located or a QoS flow of the PDU session, or a store-and-forward mode is not activated, the UPF directly transmits the data packet to a destination outside a storage function network element(for example, for an uplink data packet, the UPF may transmit the uplink data packet to the destination, such as the service server; and for a downlink data packet, the UPF may transmit the downlink data packet to the destination, such as another UPF or a base station) after receiving the indication information rather than storing the data packet into the storage function network element. If the SMF indicates, to the UPF by using the indication information, that the store-and-forward operation needs to be performed on the PDU session in which the data packet is located or the QoS flow of the PDU session, or the store-and-forward mode is activated, the UPF determines storage time information of the data packet, first transmits the data packet and the storage time information of the data packet to the storage function network element for storage, and then waits for an appropriate time to forward the data packet from the storage function network element.

In some embodiments, when receiving the indication information from the SMF, the UPF may forward, according to the indication information, a corresponding received data packet to the storage function network element for storage. In some embodiments, after receiving the indication information from the SMF, the UPF may further determine, with reference to a status (for example, a transmission capability and a network status) of the UPF, whether to perform forwarding and storage of a data packet to the storage function network element according to the indication information.

In this embodiment of the present disclosure, the indication information sent by the SMF to the UPF may be represented in any suitable manner, provided that the indication information can have a function of indicating whether the UPF forwards and stores a received data packet into the storage function network element. For example, the indication information may be represented by “Yes” or “No”. If the indication information is “Yes”, it indicates the UPF to forward and store a received data packet of a corresponding PDU session or a QoS flow of the PDU session. If the indication information is “No”, it indicates that the UPF does not need to forward and store a received data packet of a corresponding PDU session or of a QoS flow of the PDU session. For another example, the indication information may be configured for indicating whether to perform the store-and-forward operation. If the UPF receives the indication information from the SMF, it may indicate the UPF to perform the store-and-forward operation. If the UPF does not receive the indication information from the SMF, it may indicate the UPF not to perform the store-and-forward operation. For another example, the indication information may indicate whether the UPF activates the store-and-forward mode. If the UPF receives the indication information from the SMF, it may indicate the UPF to activate the store-and-forward mode. If the UPF does not receive the indication information from the SMF, it may indicate the UPF not to activate the store-and-forward mode. However, the present disclosure is not limited to the foregoing example descriptions.

In the foregoing embodiments, an example in which the SMF transmits the indication information to the UPF is used, but this disclosure is not limited thereto. In another embodiment, the SMF may not transmit the indication information to the UPF, and the UPF determines, according to a status (for example, one or more of a transmission capability, a forwarding requirement of a received data packet, and a network status) of the UPF, whether to forward a received data packet to the storage function network element for storage.

In this embodiment of the present disclosure, the SMF determines, based on configuration information of the SMF, according to parameters such as a data network name (DNN), a slice identifier (S-NSSAI, which is a network slice for establishing a PDU session), and a session and service continuity (SSC) mode of the PDU session, depending on that an application function (AF) indicates that a service is a delay-insensitive service or indicates that the store-and-forward operation may be performed on data of the service, or according to policy information of a policy control function (PCF), whether to indicate, to the UPF, that the store-and-forward operation needs to be performed on the PDU session or the QoS flow of the PDU session or the store-and-forward mode is activated for the PDU session or the QoS flow of the PDU session. The UPF determines, according to the indication of the SMF, whether the store-and-forward operation needs to be performed on the data packet.

In this embodiment of the present disclosure, after receiving the indication of the SMF, the UPF may further determine, according to one or more of a data transmission capability of the UPF, a network congestion status, a transmission delay requirement of the data packet, a priority of the data packet, and the like, whether to perform the store-and-forward operation. For example, if a current transmission capability of the UPF is that all received data packets can be transmitted, the UPF may directly transmit all the received data packets to a destination outside the storage function network element. For another example, if a current transmission capability of the UPF is that all received data packets cannot be transmitted, the UPF may determine, according to transmission delay requirements of the data packets, priorities of the data packets, and the like, a service data packet that needs to be transmitted preferentially, and store remaining data packets into the storage function network element. In this way, a system may preferentially schedule some services having relatively high delay requirements, and delay forwarding of data packets of some services that are insensitive to a delay, so as to ensure and meet transmission requirements of more services when network resources are limited.

In this embodiment of the present disclosure, the storage time information of the data packet is configured to indicate information related to duration for which the data packet is stored into the storage function network element, or information related to a time at which the storage function network element transmits the data packet to a destination outside the storage function network element after receiving the data packet. For example, the storage time information of the data packet may include at least one of a latest forwarding time, a suggested forwarding time, suggested storage duration, maximum storage duration, and the like of the data packet.

The latest forwarding time is configured to indicate the storage function network element to transmit the data packet to a destination outside the storage function network element before the latest forwarding time. The suggested forwarding time is configured to suggest that the storage function network element transmits the data packet to a destination outside the storage function network element at the suggested forwarding time. The suggested storage duration is configured to suggest that the storage function network element start timing when receiving the data packet, and transmit the data packet to the destination outside the storage function network element when the suggested storage duration is reached. The maximum storage duration is configured to indicate the storage function to start timing when receiving the data packet, and transmit the data packet to the destination outside the storage function network element before the maximum storage duration is reached.

S320: Store the data packet and the storage time information of the data packet.

After receiving the data packet and the storage time information of the data packet from the UPF, the storage function may store the data packet and the storage time information of the data packet in an associated manner according to an indication of the UPF.

S330: Determine a transmitting time of the data packet according to the storage time information.

In an exemplary embodiment, the determining a transmitting time of the data packet according to the storage time information of the data packet may be specifically: determining, if the storage time information includes the latest forwarding time of the data packet, the transmitting time of the data packet according to a capacity of the storage function network element and/or a forwarding requirement of a data packet already stored in the storage function network element, the transmitting time being earlier than the latest forwarding time; determining, if the storage time information includes the suggested forwarding time of the data packet, the transmitting time according to the suggested forwarding time; recording, if the storage time information includes the suggested storage duration of the data packet, a receiving time of at which the data packet is received from the user plane function, and determining the transmitting time according to the suggested storage duration and the receiving time; and recording, if the storage time information includes the maximum storage duration of the data packet, a receiving time of the data packet, and determining the transmitting time according to the maximum storage duration and the receiving time.

If the storage function network element receives the latest forwarding time of the data packet from the UPF in S320, the storage function network element forwards the data packet to the destination outside the storage function network element before the latest forwarding time. In this case, the specific transmitting time of the data packet may be determined according to the capacity of the storage function network element and/or a forwarding requirement of each data packet already stored in the storage function network element. For example, when a data amount of a data packet already stored in the storage function network element reaches a predetermined percentage (for example, 80%, which is merely used as an example for description herein, and is not limited thereto) of the capacity of the storage function network element, the data packet may be transmitted to the destination outside the storage function network element in advance before the latest forwarding time, so that the storage function network element can receive a data packet subsequently sent by the UPF.

In this embodiment of the present disclosure, a forwarding requirement of a stored data packet may include a latest forwarding time and/or a priority of each data packet. For example, assuming that the storage function network element stores a plurality of data packets having the same latest forwarding time, a time offset may be randomly generated for each data packet. Different data packets have different time offsets, timing starts when the storage function network element receives the data packet, and the corresponding data packet is transmitted to the destination outside the storage function network element when the time offset is reached. This can avoid a relatively large transmitting pressure on the UPF caused by simultaneously transmitting the plurality of data packets to the destination outside the storage function network element, for example, to the UPF, and all the data packets are randomly transmitted to the destination outside of the storage function network element at different time points. For another example, a fixed offset may alternatively be allocated to each data packet, and different offsets, for example, 1s (second) and 2s, are allocated to different data packets. For another example, a percentage time point may be set, and a corresponding data packet is forwarded to the destination outside the storage function network element when a predetermined percentage of duration between a receiving time (a time at which the storage function network element receives the data packet from the UPF) and a latest forwarding time is met. For another example, various sorting algorithms may alternatively be set, and each data packet is transmitted to the destination outside the storage function network element according to sorting. When the forwarding requirement includes the priority of the data packet, for the plurality of data packets having the same latest forwarding time, a data packet with a high priority may be first transmitted. In this case, the UPF may further transmit a priority of a quality of service (QoS) flow to which a data packet belongs to a data storage network element.

If in S320, the storage function network element receives the suggested forwarding time of the data packet from the UPF, the storage function network element may forward the data packet at the suggested forwarding time. However, the present disclosure is not limited thereto. The storage function network element may further determine the specific transmitting time of the data packet by comprehensively considering one or more of the capacity of the storage function network element, the current transmission capability of the UPF, the network congestion status, the forwarding requirement of each data packet already stored in the storage function network element, a suggested forwarding time of each stored data packet, and the like.

If in S320, the storage function network element receives the suggested storage duration of the data packet from the UPF, the storage function network element may simultaneously record the receiving time at which the storage function network element receives the data packet, and transmit the data packet to the destination outside the storage function network element according to the suggested storage duration, for example, transmit the data packet to the UPF. However, the present disclosure is not limited thereto. The storage function network element may further determine the specific transmitting time of the data packet by comprehensively considering one or more of the capacity of the storage function network element, the current transmission capability of the UPF, the network congestion status, the forwarding requirement of each data packet already stored in the storage function network element, suggested storage duration of each stored data packet, and the like.

If in S320, the storage function network element receives the maximum storage duration of the data packet from the UPF, the storage function network element may simultaneously record the receiving time at which the storage function network element receives the data packet, and transmit the data packet to the destination outside the storage function network element, for example, transmit the data packet to the UPF, before the maximum storage duration ends. However, the present disclosure is not limited thereto. The storage function network element may further determine the specific transmitting time of the data packet by comprehensively considering one or more of the capacity of the storage function network element, the current transmission capability of the UPF, the network congestion status, the forwarding requirement of each data packet already stored in the storage function network element, maximum storage duration of each stored data packet, and the like.

S340: Transmit the data packet to a destination outside the storage function network element at the transmitting time.

In some embodiments, the storage function network element may transmit the data packet to the UPF at the transmitting time. If the data packet is an uplink data packet, the data packet is sent to the service server through the UPF. If the data packet is a downlink data packet, the data packet is transmitted to another UPF or a base station through the UPF, and the downlink data packet is further transmitted to a UE. In some other embodiments, for the uplink data packet, the storage function network element may transmit the data packet to the service server at the transmitting time. In other words, the data packet does not need to be first transmitted back to the UPF, and then is forwarded to the destination outside the storage function network element by the UPF. In the following embodiments, an example in which the storage function network element first transmits the data packet to the UPF is used for description, but the present disclosure is not limited thereto.

In an exemplary embodiment, if the storage function network element is shared by a plurality of user plane functions, the method provided in this embodiment of the present disclosure may further include: recording identification information of a user plane function transmitting a data packet. Correspondingly, transmitting the data packet to the destination outside the storage function network element at the transmitting time may be specifically: transmitting, at the transmitting time, the data packet to the user plane function corresponding to the identification information.

If the storage function network element is shared by the plurality of UPFs, when receiving the data packet from the UPF in S310, the storage function network element may record identification information of the UPF from which the data packet is received, and transmit the received data packet to the UPF corresponding to the identification information at the transmitting time in S340. If the storage function network element is unique to the UPF, the storage function network element may directly transmit the data packet to the UPF.

According to the data packet transmission method provided in this embodiment of the present disclosure, a storage function network element is added to a user plane of a mobile core network, and a data packet in a user plane function may be stored through the storage function network element. In this way, a data transmission pressure of the user plane function can be relieved, so that the user plane function can preferentially transmit a more urgent data packet when network resources are limited, thereby ensuring and meeting a service response requirement. In addition, for a data packet stored in the storage function network element, a transmitting time of the data packet may be obtained by using storage time information, so that the data packet can be forwarded to the destination outside the storage function network element at an appropriate time.

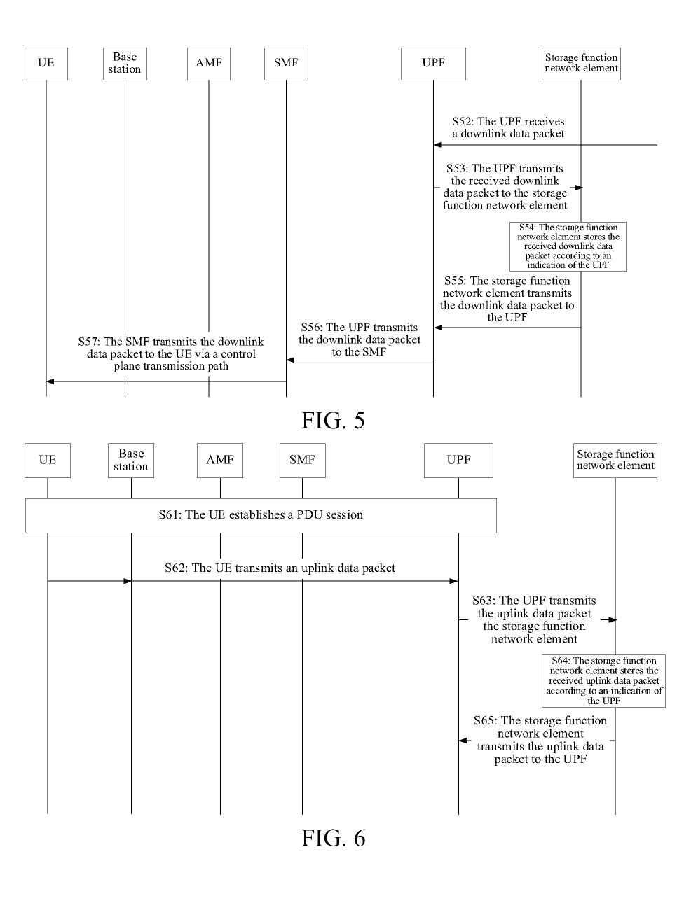

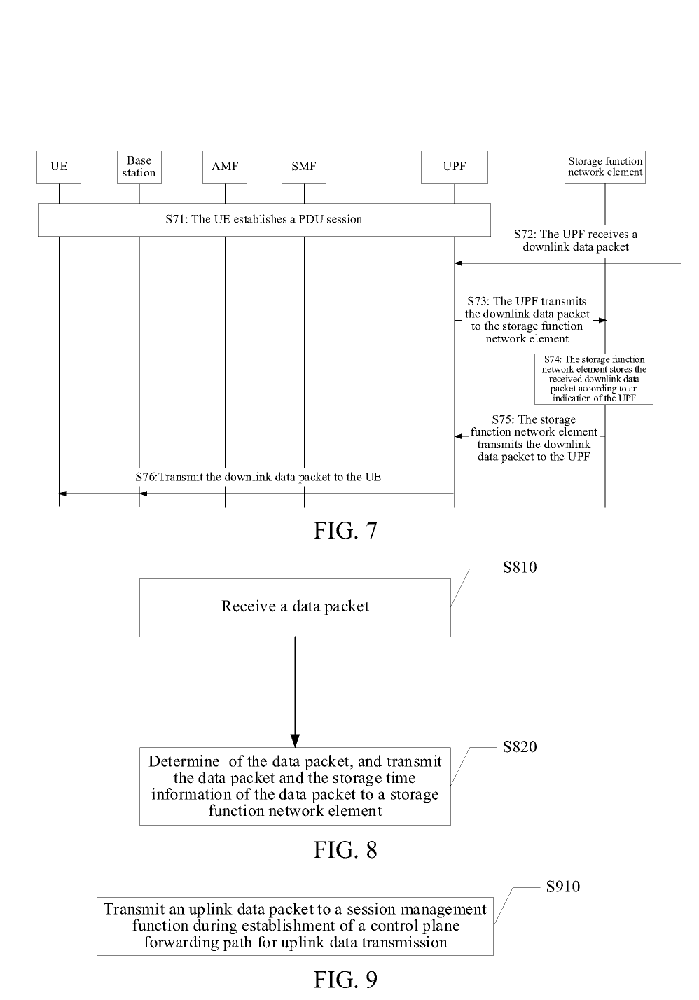

The newly added storage function network element is described below by using examples with reference to FIG. 4, FIG. 5, FIG. 6, and FIG. 7 respectively.

A base station mentioned in the following embodiments may be a base station having a new radio (NR) satellite access technology in a satellite and mobile network integrated system, or a base station deployed on a satellite, or a base station using a satellite link as a backhaul. The present disclosure is not limited thereto. In some other embodiments, the base station in the following embodiments may alternatively be a base station in a mobile network system.

In the satellite and mobile network integrated system, regardless of a satellite access system or a satellite-based backhaul system, there are problems of a relatively large transmission delay and limited transmission resources. Therefore, for a service having a low delay requirement, to effectively schedule a transmission resource, a system considers placing data packets of some delay-insensitive services in the storage function network element for storage, and then forwarding the data packets at appropriate time points. In this way, the system can preferentially schedule data packets of some services having relatively high delay requirements, and delay forwarding of data packets of some delay-insensitive services. In this way, when network resources are limited, transmission requirements of more services can be ensured and met.

FIG. 4 is a schematic interactive diagram of applying a data packet transmission method to an uplink data packet according to an embodiment of the present disclosure. As shown in FIG. 4, the method provided in this embodiment of the present disclosure may include the following operations.

S41: A UE establishes a control plane transmission path for data transmission. An example in which the UE establishes the control plane transmission path for uplink data transmission is used below for description, but the present disclosure is not limited thereto.

For example, the UE establishes a control plane forwarding path for uplink data transmission, and reference may be made to first to fourth operations in Clause 4.21.4 of TS 23.502 v18.3.0. The UE includes a protocol data unit (PDU) session identity (ID) and an uplink data packet in this process.

In some embodiments, in the process, when transmitting the uplink data packet in S41, the UE may include a time parameter of the data packet (in some embodiments, the UE may further include a data flow direction of the data packet, where the data flow direction indicates that a value of the time parameter is applicable to the uplink data packet and/or a downlink data packet). The time parameter is configured to indicate information related to a transmitting time for transmitting the data packet between the UE and a service server. For example, the time parameter may include a latest time (referred to as a latest arrival time) at which the uplink data packet is transmitted from the UE to the service server and/or a maximum value of a transmission delay of the uplink data packet transmitted from the UE to the service server, and/or a latest arrival time at which the downlink data packet is transmitted from the service server to the UE and/or a maximum value of a transmission delay of the downlink data packet.

In the process, an SMF receives the uplink data packet. In some embodiments, the SMF further receives the time parameter of the data packet. In some embodiments, whether a value of a corresponding time parameter is applicable to the uplink data packet, the downlink data packet, or both the uplink data packet and the downlink data packet may be indicated by using the data flow direction. When the time parameter is included but the data flow direction is not included, it may indicate that the time parameter is applicable to both the uplink data packet and the downlink data packet.

In some embodiments, when the SMF receives the time parameter, and the data flow direction indicates that the time parameter is applicable to the uplink data packet, the SMF may further determine storage time information of the uplink data packet according to the time parameter.

In some embodiments, when transmitting the uplink data packet in the process, the UE may further include the latest arrival time of the uplink data packet. In some embodiments, the SMF may determine the storage time information of the uplink data packet according to the latest arrival time. For example, the SMF may record a time at which the uplink data packet arrives at the SMF. The SMF estimates duration required for transmitting the uplink data packet from the SMF to the service server, and then determines the storage time information according to the time at which the uplink data packet arrives at the SMF, the estimated required duration, and the latest arrival time. In other words, it can be ensured that the uplink data packet can arrive at the service server before the latest arrival time.

In some embodiments, when transmitting the uplink data packet in the process, the UE may further include a timestamp and the maximum value of the transmission delay. The timestamp indicates a time at which the uplink data packet is transmitted from the UE to a destination outside the storage function network element. When receiving the uplink data packet, the SMF may obtain, through calculation according to the timestamp and a time at which the SMF receives the uplink data packet, duration spent in transmitting the uplink data packet from the UE to the SMF. The SMF has a capability of estimating the duration required for transmitting the uplink data packet from the SMF to the service server. The SMF may obtain the storage time information of the uplink data packet in the storage function network element according to the maximum value of the transmission delay, the duration spent in transmitting the uplink data packet from the UE to the SMF, and the estimated duration required for transmitting the uplink data packet from the SMF to the service server. For example, the SMF may subtract the duration spent in transmitting the uplink data packet from the UE to the SMF from the maximum value of the transmission delay, and then subtract the duration required for transmitting the uplink data packet from the SMF to the service server, to obtain the storage time information of the uplink data packet in the storage function network element. The storage time information is determined in a manner of including the timestamp in the uplink data packet sent by the UE, so that accuracy of the storage time information can be improved, and a calculation process thereof can be simplified.

In some other embodiments, when transmitting the uplink data packet in the process, the UE may further include the maximum value of the transmission delay but no timestamp. When receiving the uplink data packet, the SMF may estimate, based on a spatial location of the SMF and in consideration with a distance to the UE and a transmission speed of the uplink data packet, duration spent in transmitting the uplink data packet from the UE to the SMF. The SMF further has a capability of estimating duration required for transmitting the uplink data packet from the SMF to the service server. The SMF may obtain the storage time information of the uplink data packet in the storage function network element according to the maximum value of the transmission delay, the estimated duration spent in transmitting the uplink data packet from the UE to the SMF, and the estimated duration required for transmitting the uplink data packet from the SMF to the service server. The storage time information is determined in a manner of not including the timestamp in the uplink data packet sent by the UE, so that reforming on a UE end can be reduced, and transmission costs are not increased. Therefore, the method provided in this embodiment of the present disclosure is more universal.

In this embodiment of the present disclosure, core network elements may be arranged on the same satellite, may be arranged on the ground, or may be arranged on different satellites. When the core network elements are arranged on the same satellite, a transmission delay of the uplink data packet between different core network elements may be almost neglected. In this case, the transmission delay is mainly between the UE and the satellite. In this case, a distance between the UE and the satellite may be estimated according to a location of the UE and a location of the satellite. At a high altitude, the uplink data packet is almost transmitted at a light speed, and then duration spent in transmitting the uplink data packet between the UE and the satellite may be estimated. When the core network elements are located on the ground, distances between the UE and the core network elements may be calculated, and spent duration may also be estimated. When the core network elements are arranged on different satellites, the spent duration may be estimated according to spatial locations of the UE and the satellites as base stations and a topological relationship between different satellites. In a similar manner, duration required for transmitting the uplink data packet between the core network element and the service server may be estimated.

In some other embodiments, to calculate the storage time information of the uplink data packet more accurately, the SMF may obtain a currently used new radio (NR) satellite access type in S41. The SMF may determine the storage time information of the uplink data packet according to the currently used NR satellite access type and a received storage time parameter. The SMF may alternatively transmit the currently used NR satellite access type to the UPF, and the UPF determines the storage time information of the uplink data packet according to the received current NR satellite access type and the received storage time parameter.

In this embodiment of the present disclosure, the SMF may locally configure the currently used NR satellite access type. In some other embodiments, the SMF may receive a currently used NR satellite access type from an AMF. The AMF may determine the currently used NR satellite access type and transmit the currently used NR satellite access type to the SMF, so that when a currently accessed satellite changes or a satellite orbit changes, the SMF can still obtain a real-time current location of the satellite.

The currently used NR satellite access type may include a low-orbit, a medium-orbit, a high-orbit, and the like. The current spatial location of the satellite can be determined more accurately according to the currently used NR satellite access type, thereby more accurately estimating the spent duration and the required duration.

S42: The SMF transmits the received uplink data packet to the UPF.

In some embodiments, when transmitting the received uplink data packet to the UPF, the SMF may transmit the time parameter of the uplink data packet to the UPF, for example, the latest arrival time at which the uplink data packet needs to be transmitted to the service server, or the maximum value of the transmission delay. After receiving the uplink data packet and the time parameter of the uplink data packet, the UPF may determine, according to the received time parameter, the storage time information, for example, a latest forwarding time or a suggested forwarding time, of the uplink data packet in the storage function network element. For a manner in which the UPF determines the storage time information according to the time parameter, refer to the foregoing manner in which the SMF determines the storage time information according to the time parameter.

In some other embodiments, the SMF may determine the storage time information according to the time parameter of the uplink data packet, and then transmit the storage time information to the UPF when transmitting the uplink data packet to the UPF.

When transmitting an uplink data packet to the UPF, the SMF simultaneously transmits the time parameter and/or the storage time information that are/is of the uplink data packet to the UPF, so that different time parameters and/or storage time information may be set for different uplink data packets. Therefore, configuration of the storage time information of the uplink data packet in the storage function network element is more flexible.

In still some other embodiments, an AF may alternatively transmit the time parameter, for example, the maximum value of the transmission delay or the latest arrival time, of the service data packet (including the uplink data packet and/or a downlink data packet) to an NEF, and the NEF directly or indirectly transmits the time parameter to the UPF. The UPF determines, according to the received time parameter, storage time (namely, the storage time information) of the uplink data packet in the storage function network element, for example, obtains a latest forwarding time or a suggested forwarding time of the uplink data packet.

In some other embodiments, an AF may alternatively transmit the time parameter, for example, the maximum value of the transmission delay or the latest arrival time, of the service data packet to the SMF. The SMF transmits the time parameter to the UPF, and the UPF determines, according to the received time parameter, a storage time, namely, the storage time information of the service data packet in the storage function network element.

In yet some other embodiments, an AF may alternatively directly transmit the time parameter, for example, the maximum value of the transmission delay or the latest arrival time, of the service data packet to the UPF. The UPF determines, according to the received time parameter, a storage time, namely, the storage time information, of the service data packet in the storage function network element.

When the AF directly or indirectly transmits the time parameter to the UPF, the AF may further include information such as data packet identification information of the service data packet, and/or identification information of the AF, and/or a DNN, and/or an S-NSSAI. The data packet identification information is configured to identify a service data packet that is applicable to the time parameter. The data packet identification information may include, for example, internet protocol (IP) five-tuple information or three-tuple information. The IP five-tuple information may include a source IP address, a source port number, a destination IP address, a destination port number, and an IP protocol. The IP three-tuple information may include a destination IP address, a destination port number, and an IP protocol.

The identification information of the AF is configured for authentication and verification performed by a network on the AF.

The IP five-tuple information or the IP three-tuple information of the service data packet is used by the UPF to match related data packet information requested by the AF. In other words, the UPF directly or indirectly receives the IP five-tuple information or the IP three-tuple information, and the time parameter from the AF, and determines the storage time information according to the time parameter. When the UPF receives a service data packet, if the service data packet matches the IP five-tuple information or the IP three-tuple information transmitted by the AF, the UPF uses corresponding storage time information for the received service data packet, and stores the service data packet into the storage function network element.

In some embodiments, when the time parameter transmitted by the AF includes the latest arrival time at which the uplink data packet is transmitted from the UE to the service server and/or the maximum value of the transmission delay of the uplink data packet, the AF may further directly or indirectly transmit a UE identifier and/or a UE group identifier to the SMF and/or the UPF in order to indicate that the latest arrival time is applicable to an uplink data packet transmitted by a UE matching the UE identifier, and/or indicate that the latest arrival time is applicable to an uplink data packet transmitted by a UE group (which may include at least one UE) matching the UE group identifier.

The time parameter of the service data packet is configured through the AF, so that batch setting of the service data packet sent by the UE and/or the UE group can be implemented. The UE side does not need to separately transmit a time parameter for each service data packet, thereby reducing reforming on the UE side and achieving higher compatibility.

S43: The UPF transmits the received uplink data packet to the storage function network element.

The UPF transmits the received uplink data packet to the storage function network element. In addition, the UPF transmits the storage time information of the uplink data packet to the storage function network element. The storage time information may include the latest forwarding time, the suggested forwarding time, suggested storage duration, or maximum storage duration of the uplink data packet.

S44: The storage function network element stores the received uplink data packet according to an indication of the UPF.

The storage function network element stores the received uplink data packet and determines a transmitting time according to the storage time information. If the latest forwarding time of the uplink data packet is further received in S43, the uplink data packet is forwarded (transmitted to the UPF and/or the service server) before the latest forwarding time. A specific transmitting time of the uplink data packet may be jointly determined according to a capacity of the storage function network element and a forwarding requirement of each data packet (which may include the uplink data packet and/or the downlink data packet). If the suggested forwarding time of the uplink data packet is received in S43, the uplink data packet may be forwarded at the suggested forwarding time. If the suggested storage duration of the uplink data packet is received in S43, a receiving time at which the uplink data packet is received may be recorded at the same time, and the uplink data packet is transmitted to the UPF and/or the service server when the suggested storage duration ends. If the maximum storage duration of the uplink data packet is received in S43, a receiving time at which the uplink data packet is received may be recorded at the same time, and the uplink data packet is transmitted to the UPF and/or the service server before the maximum storage duration ends.

S45: The storage function network element transmits the uplink data packet to the UPF.

If the storage function network element is shared by a plurality of UPFs, the storage function network element may record, in S43, identification information of the UPF from which the uplink data packet is received, and transmit, when the transmitting time arrives, the uplink data packet received in S43 to the UPF corresponding to the identification information of the UPF. If the storage function network element is unique to the UPF, when the transmitting time arrives, the storage function network element may directly transmit the uplink data packet to the UPF and/or the service server. If the storage function network element may transmit the uplink data packet to the service server without using the UPF, regardless of whether the storage function network element is shared by the plurality of UPF or unique to the UPF, the storage function network element transmits the uplink data packet to the service server when the transmitting time arrives.

FIG. 5 is a schematic interactive diagram of applying a data packet transmission method to a downlink data packet according to an embodiment of the present disclosure. As shown in FIG. 5, the method provided in this embodiment of the present disclosure may include the following operations.

The control plane transmission path established in S41 in the embodiment in FIG. 4 is not limited to being configured for transmitting uplink data, and may also be configured to transmit downlink data. The control plane transmission path established in S41 may be used in S57 in FIG. 5.

In some embodiments, in a process in which the UE establishes the control plane transmission path, the UE may transmit a time parameter of a data packet to the SMF. The UE may further transmit a data flow direction of the time parameter to the SMF. The SMF may transmit the time parameter (in some embodiments, further including the data flow direction) of the data packet to the UPF. After receiving the time parameter (in some embodiments, further including the data flow direction), if it is determined that the time parameter is applicable to a downlink data packet, the UPF may determine storage time information of the downlink data packet according to the time parameter. The time parameter of the downlink data packet may include a latest arrival time at which the downlink data packet is transmitted from a service server/an AF to a UE and/or a maximum value of a transmission delay of the downlink data packet. The UPF may determine the storage time information of the downlink data packet according to the time parameter.

In some embodiments, the SMF may determine the storage time information of the downlink data packet according to the time parameter of the received downlink data packet, and then transmit the storage time information to the UPF.

S52: The UPF receives a downlink data packet.

For example, the UPF may receive the downlink data packet from a service server. In some embodiments, when transmitting the downlink data packet to the UPF, the service server may include a time parameter (in some embodiments, may further include a data flow direction) of the data packet, and the UPF may determine storage time information of the downlink data packet according to the received time parameter (in some embodiments, further including the data flow direction) of the data packet.

In some other embodiments, the AF may alternatively transmit a time parameter (in some embodiments, a data flow direction may be further included) of a data packet to an NEF, and the NEF directly or indirectly transmits the time parameter (in some embodiments, the data flow direction may be further included) to the UPF. The UPF determines the storage time information of the downlink data packet in a storage function network element according to the received time parameter that is applicable to the downlink data packet. In still some other embodiments, the AF may alternatively directly transmit a time parameter of a data packet to the UPF. The UPF determines the storage time information of the downlink data packet in a storage function network element according to the received time parameter that is applicable to the downlink data packet.

S53: The UPF transmits the received downlink data packet to the storage function network element.

In addition, the UPF may further transmit the storage time information of the downlink data packet to the storage function network element. If a plurality of UPFs share the storage function network element, the UPF may further transmit identification information of the plurality of UPFs to the storage function network element.

S54: The storage function network element stores the received downlink data packet according to an indication of the UPF.

In addition, the storage function network element further stores the storage time information of the received downlink data packet. A transmitting time of the downlink data packet is determined according to the storage time information of the received downlink data packet.

S55: The storage function network element transmits the downlink data packet to the UPF.

When the transmitting time arrives, the storage function network element transmits the downlink data packet to the destination outside the storage function network element at the determined transmitting time. Herein, an example in which the downlink data packet is transmitted to the UPF is used for description, but the present disclosure is not limited thereto. Alternatively, the storage function network element may not transmit the downlink data packet to the UE through the UPF.

S56: The UPF transmits the downlink data packet to the SMF.

After receiving the downlink data packet from the storage function network element, the UPF transmits the downlink data packet to the SMF.

S57: The SMF transmits the downlink data packet to the UE through the control plane transmission path.

In the data packet transmission method provided in this embodiment of the present disclosure, a control plane is combined with a user plane. The control plane transmission path is established to implement transmission of a service data packet, so that an air interface resource can be saved. In addition, a storage function network element is newly added to the user plane to store a service data packet that is insensitive to a delay, so that a UPF can preferentially transmit a service data packet with an urgent transmission delay in order to meet normal response requirements of different services.

FIG. 6 is a schematic interactive diagram of applying a data packet transmission method to an uplink data packet according to another embodiment of the present disclosure. As shown in FIG. 6, the method provided in this embodiment of the present disclosure may include the following operations.

S61: A UE establishes a PDU session.

For establishing the PDU session by the UE, for example, reference may be made to operation 1 to operation 14 of FIG. 4.3.2.2.1-1 in Clause 4.3.2.2.1 of TS 23.502 v18.3.0.

In the process, an SMF determines whether to indicate to a UPF that a store-and-forward operation needs to performed on the PDU session or a QoS flow of the PDU session, or a store-and-forward mode is activated for the PDU session or the QoS flow of the PDU session. The SMF indicates the UPF based on configuration information of the SMF, or according to parameters such as a DNN, an S-NSSAI, and an SSC mode of the PDU session, or depending on that an application function AF indicates that the service is a delay-insensitive service, or according to policy information of a policy control function PCF, or the like. If the SMF determines to indicate, to the UPF that the store-and-forward operation needs to be performed on the PDU session or the QoS flow of the PDU session, or the store-and-forward mode is activated for the PDU session or the QoS flow of the PDU session, the SMF transmits related indication information to the UPF. The UPF determines, according to the indication information of the SMF, whether the store-and-forward operation needs to be performed on a data packet.

In some embodiments, in the process, when initiating PDU session establishment, the UE may include a time parameter (in some embodiments, further includes a data flow direction) of the data packet, for example, a maximum value of a transmission delay and/or a latest arrival time at which the data packet arrives at a service server. After receiving the time parameter (in some embodiments, further including the data flow direction), the SMF may transmit the time parameter (in some embodiments, further including the data flow direction) of the data packet to the UPF in the process. After receiving the time parameter (in some embodiments, further including the data flow direction), the UPF may determine, depending on whether the data flow direction is carried or according to the data flow direction, a time parameter applicable to an uplink data packet, and determine storage time information of the uplink data packet according to the time parameter applicable to the uplink data packet. For example, when receiving the uplink data packet sent by the UE, the UPF calculates, according to maximum storage duration sent by the SMF, a latest forwarding time, a suggested forwarding time, suggested storage duration, or a maximum storage time of the uplink data packet. The UPF transmits the storage time information and the uplink data packet to a storage function network element. In some other embodiments, to support the UPF in calculating the storage time information of the uplink data packet more accurately, in this process, the SMF may alternatively transmit a currently used NR satellite access type to the UPF. The UPF may determine the storage time information of the uplink data packet according to the time parameter and the currently used NR satellite access type.

In some embodiments, when it is expected to update the time parameter of the data packet of the UE, the UE may initiate a PDU session update procedure. In the update procedure, an updated time parameter of the data packet of the UE is included, and the SMF or the UPF may determine updated storage time information according to the updated time parameter.

In some other embodiments, when initiating PDU session establishment in S61, the UE may include a time parameter of a data packet of the UE. The SMF calculates, according to the time parameter and the current NR satellite access type, storage time information, for example, maximum storage duration, of an uplink data packet, and transmits the storage time information, for example, the maximum storage duration, to the UPF.

In addition, the application function AF may alternatively transmit a time parameter such as a maximum value of a transmission delay (in some embodiments, further including a data flow direction) of a service data packet to an NEF, and the NEF directly or indirectly transmits the time parameter such as the maximum value of the transmission delay (in some embodiments, further including the data flow direction) to the UPF. The UPF further determines, according to the time parameter (in some embodiments, further including the data flow direction), a time at which an uplink data packet is stored in the storage function network element, or further obtains a latest forwarding time or a suggested forwarding time of each uplink data packet. The application function AF may alternatively directly transmit a time parameter such as a maximum value of a transmission delay (in some embodiments, further including a data flow direction) of a service data packet to the UPF. The AF may alternatively include IP five-tuple information of the service data packet, and/or identification information of the AF. The identification information of the AF is configured for authentication and verification on the AF by a network. The IP five-tuple information of the service data packet is used by the UPF to match related data packet information requested by the AF.

In this embodiment of the present disclosure, the time parameter is transmitted to the SMF or the UPFin the PDU session establishment or update procedure, so that batch setting of the storage time information of the uplink data packet may be implemented, reforming on the UE side is reduced, and compatibility is improved.

S62: The UE transmits an uplink data packet to a UPF through a base station.

After the PDU session is established, the UE transmits the uplink data packet to the base station. After receiving the uplink data packet sent by the UE, the base station transmits the uplink data packet to the UPF. The UPF receives the uplink data packet from the base station.

In some embodiments, when transmitting the uplink data packet to the UPF through the base station, the UE may simultaneously include a time parameter (in some embodiments, further including a data flow direction) of the data packet. The UPF may determine storage time information of the uplink data packet according to the time parameter (in some embodiments, further including the data flow direction) of the data packet. When transmitting the uplink data packet to the UPF through the base station, the UE includes the time parameter of the data packet, so that a time parameter can be set for each data packet, so that the time parameter of the data packet is more flexible.

S63: The UPF transmits the received uplink data packet to a storage function network element.

In S63, the UPF transmits the uplink data packet received in S62 to the storage function network element, and meanwhile, the UPF determines storage time information, such as a latest forwarding time, a suggested forwarding time, suggested storage duration, or a maximum value of a storage time, of the uplink data packet based on the time parameter such as the maximum value of the transmission delay (in some embodiments, further including the data flow direction) of the data packet indicated by the SMF. Alternatively, the UPF receives the uplink data packet and the storage time information of the uplink data packet from the SMF. Alternatively, the UPF directly or indirectly determines the storage time information of the uplink data packet according to the time parameter (in some embodiments, further including the data flow direction) received from the AF.

The UPF transmits the storage time information of the uplink data packet to the storage function network element. If a plurality of UPFs share the same storage function network element, the UPF further transmits identification information of the UPF to the storage function network element.

S64: The storage function network element stores the received uplink data packet according to an indication of the UPF.

In S64, the storage function network element stores the received uplink data packet and the storage time information of the uplink data packet, and determines a transmitting time of the uplink data packet according to the storage time information.

S65: The storage function network element transmits the uplink data packet to the UPF.

If the latest forwarding time of the uplink data packet is received in S63, the uplink data packet may be forwarded before the latest forwarding time. The specific transmitting time of the uplink data packet may be jointly determined according to a capacity of the storage function network element and a forwarding requirement of each data packet. If the suggested forwarding time of the uplink data packet is received in S63, the uplink data packet may be forwarded at the suggested forwarding time. If the suggested storage duration of the uplink data packet is received in S63, a receiving time at which the uplink data packet is received may be recorded at the same time, and the uplink data packet is transmitted to the UPF or a service server when the suggested storage duration ends. If the maximum storage duration of the uplink data packet is received in S63, a receiving time at which the uplink data packet is received may be recorded at the same time, and the uplink data packet is transmitted to the UPF or the service server before the maximum storage duration ends.

If the storage function network element transmits the uplink data packet received in S63 to the UPF, the UPF transmits the uplink data packet to the destination outside the storage function network element.

In this embodiment of the present disclosure, the SMF may receive the time parameter of the data packet from a UE side, the NEF, or the AF. The time parameter may include a transmitting time parameter of the uplink data packet and/or the downlink data packet. The transmitting time parameter of the uplink data packet is a latest arrival time at which the uplink data packet is transmitted from the UE to the service server and/or a maximum delay of a transmission delay of the uplink data packet. The transmitting time parameter of the downlink data packet is a latest arrival time at which the downlink data packet is transmitted from the service server/the AF to the UE and/or a maximum value of a transmission delay of the downlink data packet. If the transmitting time parameter does not indicate whether the transmitting time parameter is applicable to the uplink data packet or the downlink data packet, it indicates that the transmitting time parameter may be configured for both the uplink data packet and the downlink data packet. The transmitting time parameter may have the following two implementations, but the present disclosure is not limited thereto.

In some embodiments, the SMF may receive an uplink time parameter of the uplink data packet and/or a downlink time parameter of the downlink data packet from the UE side, the NEF, or the AF. The uplink time parameter refers to a latest arrival time at which the uplink data packet is transmitted from the UE to the service server and/or a maximum value of a transmission delay of the uplink data packet. The downlink time parameter refers to a latest arrival time at which the downlink data packet is transmitted from the service server/the AF to the UE and/or a maximum value of a transmission delay of the downlink data packet.

In some other embodiments, the SMF may receive a time parameter (In some embodiments, may further include a data flow direction of the time parameter) from the UE side, the NEF, or the AF. The data flow direction of the time parameter is configured to indicate that the time parameter is applicable to the uplink data packet or the downlink data packet, or is applicable to both the uplink data packet and the downlink data packet. If the SMF receives only the time parameter and does not receive the data flow direction, it may indicate that the time parameter is applicable to both the uplink data packet and the downlink data packet. The time parameter applicable to the uplink data packet is a latest arrival time at which the uplink data packet is transmitted from the UE to the service server and/or a maximum value of a transmission delay of the uplink data packet. The time parameter applicable to the downlink data packet is a latest arrival time at which the downlink data packet is transmitted from the service server/the AF to the UE and/or a maximum value of a transmission delay of the downlink data packet.

FIG. 7 is a schematic interactive diagram of applying a data packet transmission method to a downlink data packet according to another embodiment of the present disclosure. As shown in FIG. 7, the method provided in this embodiment of the present disclosure may include the following operations.

S71: A UE establishes a PDU session.

S72: A UPF receives a downlink data packet.

S73: The UPF transmits the received downlink data packet to a storage function network element. In addition, the UPF further transmits storage time information of the downlink data packet to the storage function network element. For determining the storage time information of the downlink data packet, refer to the foregoing embodiments.

S74: The storage function network element stores the received downlink data packet according to an indication of the UPF. The storage function network element further receives the storage time information of the downlink data packet, and determines a transmitting time of the downlink data packet based on the storage time information.

S75: The storage function network element transmits the downlink data packet to the UPF. The storage function network element transmits the downlink data packet to the UPF at the transmitting time. In some other embodiments, the storage function network element may alternatively transmit the downlink data packet to a base station.

S76: The UPF transmits the downlink data packet to the UE through the base station.

The UPF transmits the downlink data packet received from the storage function network element to the base station, and the base station forwards the downlink data packet to the UE. Alternatively, the base station forwards the downlink data packet received from the storage function network element to the UE.

In a current communication network system, communication between a core network and a mobile terminal may be implemented through a satellite link. However, the satellite link usually causes a high delay, and if delay requirements of some services of a terminal cannot be meet, the services cannot not be normally responded. For example, in some special cases, when a terminal is located in a remote region such as an island, an isolated forest, or a mountainous region, a satellite link needs to be used. The satellite link cannot respond to some services according to a severe low-delay service quality standard, and the satellite link cannot meet an actual requirement. The data packet transmission method provided in this embodiment of the present disclosure may be applied to user plane data processing of a satellite and mobile network integrated system. For an integrated system of a satellite and a mobile communication network, considering that transmission resources of the satellite are relatively small, data of services that are insensitive to a delay is stored and forwarded, so that service data can be effectively scheduled through limited transmission resources.

FIG. 8 is a flowchart of a data packet transmission method according to another embodiment of the present disclosure. The method provided in the embodiment of FIG. 8 may be performed by a user plane function, but the present disclosure is not limited thereto. As shown in FIG. 8, the method provided in this embodiment of the present disclosure may include the following operations.

S810: Receive a data packet.

In an exemplary embodiment, the data packet includes an uplink data packet. The receiving a data packet includes: receiving the uplink data packet from a session management function.

In an exemplary embodiment, the data packet includes an uplink data packet. The receiving a data packet includes: receiving the uplink data packet from a base station.

In an exemplary embodiment, the base station is any one of (i) a base station having a new radio (NR) satellite access technology, (ii) a base station deployed on a satellite, and (iii) a base station using a satellite link as a backhaul.

S820: Determine storage time information of the data packet; transmit the data packet and the storage time information of the data packet to a storage function network element; indicate the storage function network element to store the data packet and the storage time information of the data packet; determine a transmitting time of the data packet based on the storage time information; and transmit the data packet to the destination outside the storage function network element at the transmitting time.

In an exemplary embodiment, the determining storage time information of the data packet includes: receiving storage time information of the uplink data packet from the session management function.

In an exemplary embodiment, the determining storage time information of the data packet includes: receiving a time parameter of the data packet from the session management function, where the time parameter includes a latest arrival time and/or a maximum value of a transmission delay that are/is of the data packet; and determining storage time information of the uplink data packet according to the time parameter of the data packet.

In an exemplary embodiment, the determining storage time information of the data packet includes: receiving a time parameter of the data packet from the session management function in a protocol data unit session establishment or update procedure, where the time parameter includes a latest arrival time and/or a maximum value of a transmission delay that are/is of the data packet; and determining storage time information of the uplink data packet according to the time parameter of the data packet.

In an exemplary embodiment, the determining storage time information of the uplink data packet according to the time parameter of the data packet includes: receiving current satellite access type information from the session management function; and determining the storage time information of the uplink data packet according to the current satellite access type information and the time parameter.

In an exemplary embodiment, the determining storage time information of the data packet includes: receiving storage time information of an uplink data packet from the session management function in a protocol data unit session establishment or update procedure.

In an exemplary embodiment, the uplink data packet carries a time parameter. The determining storage time information of the data packet includes: determining storage time information of the uplink data packet according to the time parameter carried in the uplink data packet.

In an exemplary embodiment, the determining storage time information of the data packet includes: directly or indirectly obtaining a time parameter of a data packet and data packet identification information from an application function; and determining the time parameter of the data packet as the time parameter of the data packet if the data packet matches the data packet identification information, the time parameter including a latest arrival time and/or a maximum value of a transmission delay that are/is of the data packet; and determining storage time information of the data packet according to the time parameter of the data packet.

In an exemplary embodiment, the determining storage time information of the data packet, and transmitting the data packet and the storage time information of the data packet to a storage function network element includes: receiving indication information; determining, according to the indication information, whether to determine the storage time information of the data packet; and transmitting the data packet and the storage time information of the data packet to the storage function network element.

For other content of the embodiment of FIG. 8, refer to the foregoing embodiments.

FIG. 9 is a flowchart of a data packet transmission method according to still another embodiment of the present disclosure. The method provided in the embodiment of FIG. 9 may be performed by the terminal, but the present disclosure is not limited thereto. As shown in FIG. 9, the method provided in this embodiment of the present disclosure may include the following operations.

S910: Transmit an uplink data packet to a session management function during establishment of a control plane forwarding path for uplink data transmission, so that the session management function transmits the uplink data packet to a user plane function.

The user plane function is configured to receive the uplink data packet, determine storage time information of the uplink data packet, and transmit the uplink data packet and the storage time information of the uplink data packet to a storage function network element.

In an exemplary embodiment, the method provided in this embodiment of the present disclosure further includes: transmitting a time parameter of the uplink data packet to the session management function, the time parameter including a latest arrival time at which the uplink data packet is transmitted from a terminal to a service server and/or a maximum value of a transmission delay of the uplink data packet.

In an exemplary embodiment, the transmitting a time parameter of the uplink data packet to the session management function includes: including the time parameter of the uplink data packet to the uplink data packet; and transmitting the uplink data packet to the session management function.

In an exemplary embodiment, the transmitting a time parameter of the uplink data packet to the session management function includes: transmitting the time parameter of the uplink data packet to the session management function in a protocol data unit session establishment or an update procedure.

For other content of the embodiment of FIG. 9, refer to the foregoing embodiments.

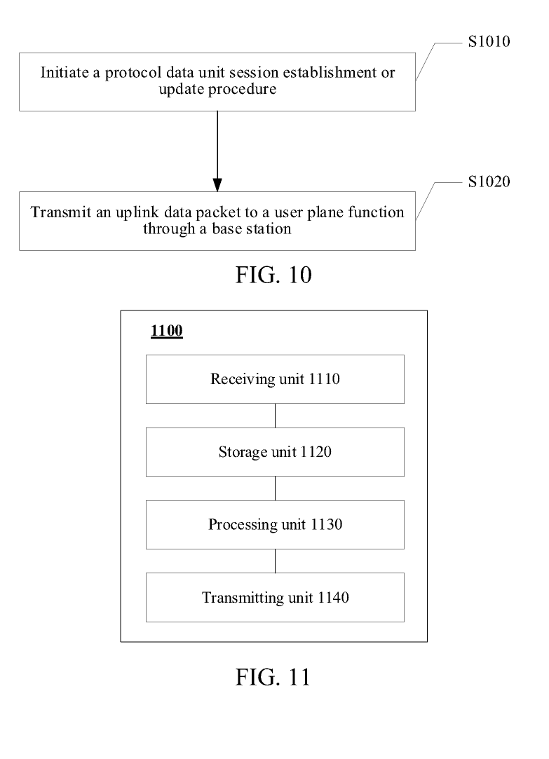

FIG. 10 is a flowchart of a data packet transmission method according to yet another embodiment of the present disclosure. The method provided in FIG. 10 may be performed by a terminal, but the present disclosure is not limited thereto. As shown in FIG. 10, the method provided in this embodiment of the present disclosure may include the following operations.

S1010: Initiate a protocol data unit session establishment or update procedure.

S1020: Transmit an uplink data packet to a user plane function through a base station.

The user plane function is configured to receive the uplink data packet, determine storage time information of the uplink data packet, and transmit the uplink data packet and the storage time information of the uplink data packet to a storage function network element.

In an exemplary embodiment, the method provided in this embodiment of the present disclosure further includes: transmitting a time parameter of the uplink data packet to a session management function in the protocol data unit session establishment or an update procedure, the time parameter including a latest arrival time at which the uplink data packet is transmitted from the terminal to a service server and/or a maximum value of a transmission delay of the uplink data packet.

In an exemplary embodiment, when the uplink data packet is transmitted to the user plane function through a base station, the uplink data packet carries the time parameter of the uplink data packet.

For other content of the embodiment of FIG. 10, refer to the foregoing embodiments.

FIG. 11 is a block diagram of a storage function network element according to an embodiment of the present disclosure. A storage function network element 1100 in the user plane of the mobile core network provided in FIG. 10 may include a receiving unit 1110, a storage unit 1120, a processing unit 1130, and a transmitting unit 1140.

The receiving unit 1110 is configured to receive the data packet and storage time information of the data packet from the user plane function. The storage unit 1120 is configured to store the data packet and storage time information of the data packet. The processing unit 1130 is configured to determine the transmitting time of the data packet according to the storage time information. The transmitting unit 1140 is configured to transmit the data packet at the transmitting time.

In an exemplary embodiment, a function of the storage function network element is integrated into the user plane function.

In an exemplary embodiment, the processing unit 1130 is further configured for: determining, if the storage time information includes the latest forwarding time of the data packet, the transmitting time of the data packet according to the capacity of the storage function network element and/or the forwarding requirement of the data packet already stored in the storage function network element, where the transmitting time is earlier than the latest forwarding time; and determining a transmitting time according to a suggested forwarding time, if the storage time information includes the suggested forwarding time of the data packet; and recording, if the storage time information includes the suggested storing duration of the data packet, the receiving time at which the data packet is received from the user plane function, and determining a transmitting time according to the suggested storing duration and the receiving time; and recording, if the storage time information includes the maximum storage duration of the data packet, the receiving time of the data packet, and determining the transmitting time according to the maximum storage duration and the receiving time.

In an exemplary embodiment, if the storage function network element is shared by the plurality of user plane functions, the storage function network element 1100 further includes: a recording unit configured to record identification information of the user plane function transmitting the data packet. The transmitting unit 1140 is further configured to transmit, at the transmitting time, the data packet to the user plane function corresponding to the identification information.

For other content of the storage function network element provided in the embodiment of FIG. 11, refer to the foregoing other embodiments.

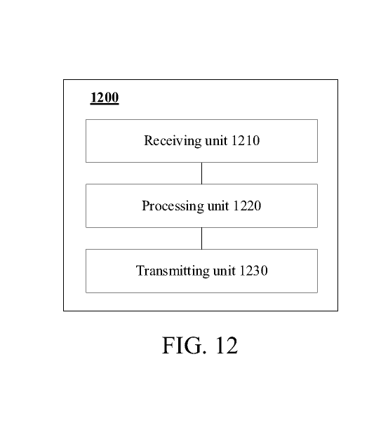

FIG. 12 is a block diagram of a user plane function network element according to an embodiment of the present disclosure. As shown in FIG. 12, the user plane function 1200 provided in this embodiment of the present disclosure may include a receiving unit 1210, a processing unit 1220, and a transmitting unit 1230.

The receiving unit 1210 receives the data packet. The processing unit 1220 determines the storage time information of the data packet. The transmitting unit 1230 transmits the data packet and the storage time information of the data packet to the storage function network element in order to instruct the storage function network element to store the data packet and the storage time information of the data packet, determine the transmitting time of the data packet according to the storage time information, and transmit the data packet at the transmitting time.

In an exemplary embodiment, the data packet includes the uplink data packet. The receiving unit 1210 is further configured to receive an uplink data packet from a session management function.

In an exemplary embodiment, the processing unit 1220 is further configured to receive the storage time information of the uplink data packet from the session management function.

In an exemplary embodiment, the processing unit 1220 is further configured to receive the time parameter of the data packet from the session management function, where the time parameter includes the latest arrival time and/or the maximum value of the transmission delay of the data packet; and determining the storage time information of an uplink data packet according to the time parameter of the data packet.

In an exemplary embodiment, the data packet includes the uplink data packet. The receiving unit 1210 is further configured to receive the uplink data packet from the base station.

In an exemplary embodiment, the base station is any one of (i) the base station having the new radio satellite access technology, (ii) the base station deployed on the satellite, and (iii) the base station using the satellite link as the backhaul.

In an exemplary embodiment, the processing unit 1220 is further configured to receive the time parameter of the data packet from the session management function in the protocol data unit session establishment or update procedure, where the time parameter includes the latest arrival time and/or the maximum value of the transmission delay of the data packet; and determining storage time information of the uplink data packet according to the time parameter of the data packet.

In an exemplary embodiment, the processing unit 1220 is further configured to receive current satellite access type information from the session management function; and determining the storage time information of an uplink data packet according to the current satellite access type information and the time parameter.

In an exemplary embodiment, the processing unit 1220 is further configured to receive the storage time information of the uplink data packet from the session management function in the protocol data unit session establishment or an update procedure.

In an exemplary embodiment, the uplink data packet carries the time parameter. The processing unit 1220 is further configured to determine storage time information of the uplink data packet according to the time parameter carried in the uplink data packet.

In an exemplary embodiment, the processing unit 1220 is further configured to directly or indirectly obtain the time parameter and the data packet identification information of the data packet from the application function; determine, if the data packet matches the data packet identification information, the time parameter of the data packet as the time parameter of the data packet, where the time parameter includes a latest arrival time and/or a maximum value of a transmission delay of the data packet; and determine storage time information of the data packet according to the time parameter of the data packet.

For other content of the user plane function provided in the embodiment of FIG. 12, refer to the foregoing other embodiments.

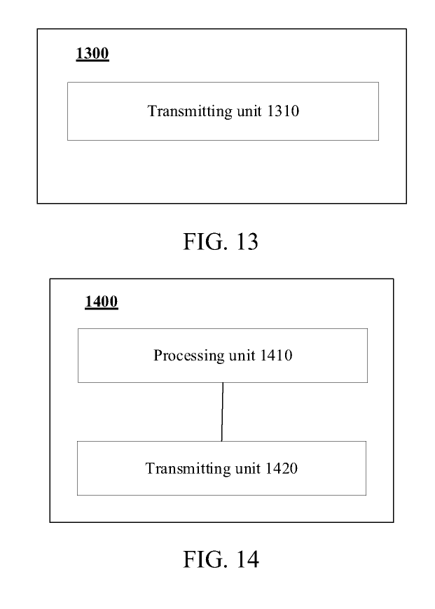

FIG. 13 is a schematic block diagram of a terminal according to an embodiment of the present disclosure. The terminal 1300 provided in the embodiment of FIG. 13 may include a transmitting unit 1310. The transmitting unit 1310 is configured to transmit the uplink data packet to the session management function during establishment of the control plane forwarding path for uplink data transmission, so that the session management function transmits the uplink data packet to a user plane function. The user plane function is configured to receive an uplink data packet, determine the storage time information of the uplink data packet, and transmit the uplink data packet and the storage time information of the uplink data packet to the storage function network element.

In an exemplary embodiment, the transmitting unit 1310 is further configured to transmit the time parameter of the data packet to the session management function, where the time parameter includes the latest arrival time and/or the maximum value of a transmission delay of the data packet.

In an exemplary embodiment, the transmitting unit 1310 is further configured to add the time parameter of the data packet to the uplink data packet to transmit the uplink data packet to the session management function.

In an exemplary embodiment, the transmitting unit 1310 is further configured to transmit the time parameter of the data packet to the session management function in the protocol data unit session establishment or update procedure.

For other content of the terminal provided in the embodiment of FIG. 13, refer to the foregoing other embodiments.

FIG. 14 is a block diagram of a terminal according to another embodiment of the present disclosure. The terminal 1400 provided in the embodiment of FIG. 14 may include a processing unit 1410 and a transmitting unit 1420. The processing unit 1410 is configured to initiate establishment or updating of the protocol data unit session procedure. The transmitting unit 1420 is configured to transmit the uplink data packet to the user plane function by using the base station. The user plane function is configured to receive an uplink data packet, determine the storage time information of the uplink data packet, and transmit the uplink data packet and the storage time information of the uplink data packet to the storage function network element.

In an exemplary embodiment, the transmitting unit 1420 is further configured to transmit the time parameter of the data packet to the session management function in a procedure of establishing or updating the protocol data unit session, the time parameter including the latest arrival time and/or the maximum value of the transmission delay of the data packet.

In an exemplary embodiment, when the uplink data packet is sent to the user plane function by using the base station, the uplink data packet carries the time parameter.

For other content of the terminal provided in the embodiment of FIG. 14, refer to the foregoing other embodiments.

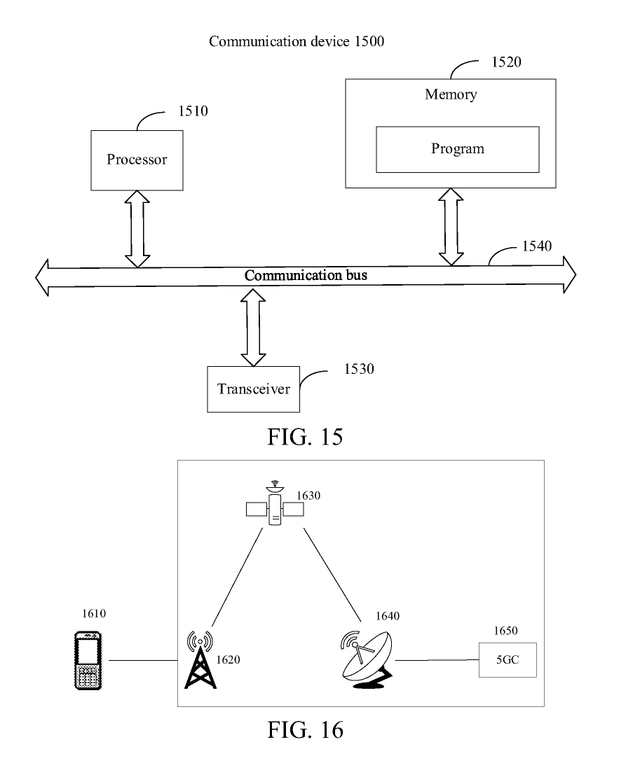

FIG. 15 is a schematic structure diagram of a communication device 1500 according to an embodiment of the present disclosure. The communication device may be a terminal such as a UE, or may be a network device such as a base station, or may be a PCF network element and/or an NEF network element and/or an PF network element and/or an SMF and/or a UPF and/or a storage function network element. The communication device 1500 shown in FIG. 15 includes a processor 1510. The processor 1510 may invoke and run a computer program from a memory in order to implement the method in the embodiments of the present disclosure.

In some embodiments, as shown in FIG. 15, the communication device 1500 may further include a memory 1520. In this embodiment, the processor 1510 is from an execution of the computer program stored in the memory 1520 in order to implement the operations shown in the foregoing method embodiments.

The memory 1520 may be an independent component independent of the processor 1510, or may be integrated in the processor 1510.

In some embodiments, as shown in FIG. 15, the communication device 1500 may further include a transceiver 1530. The processor 1510 may control the transceiver 1530 to communicate with another device, and specifically, may transmit information or data to another device, or receive information or data sent by another device.

The transceiver 1530 may include a transmitter (which may be used as a transmitting unit in the foregoing embodiment) and a receiver (which may be used as a receiving unit in the foregoing embodiment). The transceiver 1530 may further include one or more antennas.

In some embodiments, the communication device 1500 may be various network elements in the embodiments of the present disclosure, and the communication device 1500 may implement corresponding processes implemented by the network elements in the methods in the embodiments of the present disclosure. For brevity, details are not described herein again.

In some embodiments, the communication device 1500 may be a mobile terminal/terminal in this embodiment of the present disclosure, and the communication device 1500 may implement corresponding processes implemented by the mobile terminal/terminal in the methods in this embodiment of the present disclosure. For brevity, details are not described herein again.

In some embodiments, bidirectional communication between the processor 1510, the memory 1520, and the transceiver 1530 may be implemented by using the communication bus 1540.

The method provided in this embodiment of the present disclosure may be applied to a 5G network and satellite system fusion system shown in any one of the following embodiments in FIG. 16 to FIG. 18.

As shown in FIG. 16, a fusion system between a 5G network and a satellite system provided in an embodiment of the present disclosure may include a UE 1610, a base station (for example, a gNB) 1620, a satellite 1630, a message watching station 1640, and a 5G core (5GC) 1650. The UE 1610 communicates with the base station 1620. The base station 1620 is arranged on the ground. The satellite 1630 is configured to return a downlink data packet to the base station 1620, and/or return an uplink data packet to the 5GC 1650. In some embodiments, communication may further be performed between the satellite 1630 and the 5GC 1650 through a messaging station 1640.

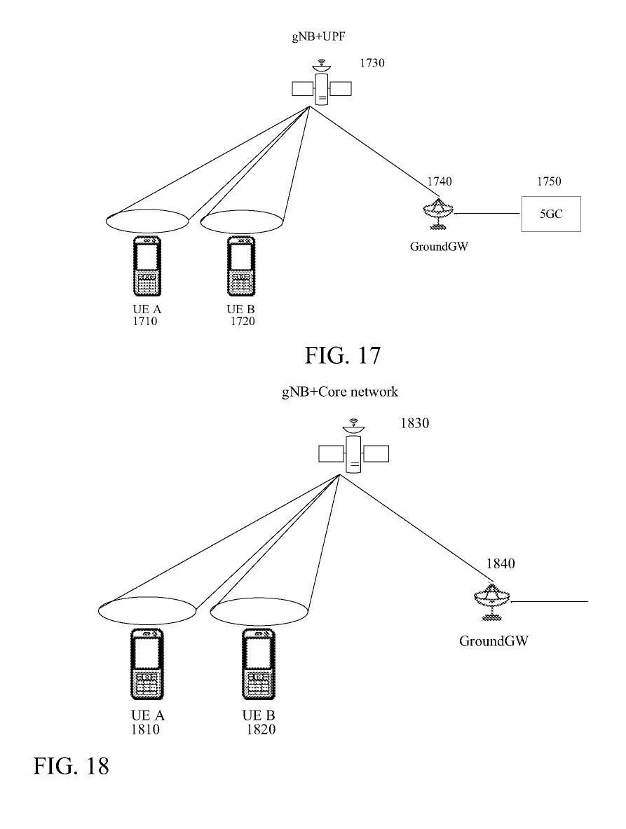

As shown in FIG. 17, a fusion system between the 5G network and a satellite system provided in an embodiment of the present disclosure may include a UE A 1710, a UE B 1720, a satellite 1730, a ground gateway (GW) 1740, and a 5GC 1750. In the embodiment of FIG. 17, functions of the base station (for example, the gNB) and the UPF may be set on the satellite 1730, to implement NR satellite access, which is a star on the UPF. A UE A 1710 and a UE B 1720 communicate with a satellite 1730, the satellite 1730 communicates with a ground GW 1740, and the ground GW 1740 communicates with 5GC 1750.

As shown in FIG. 18, a fusion system between a 5G network and a satellite system provided in an embodiment of the present disclosure may include a UE A 1810, a UE B 1820, a satellite 1830, and a ground GW 1840. In the embodiment of FIG. 18, functions of a base station (for example, a gNB) and a core network may be arranged on the satellite 1830 in order to implement NR satellite access, and a star on the core network. The UE A 1810 and the UE B 1820 communicate with the satellite 1830, and the satellite 1830 communicates with the ground GW 1840.

The processor in this embodiment of the present disclosure may be an integrated circuit chip, and has a signal processing capability. In an implementation process, the steps of the foregoing method embodiments may be completed by using a hardware integrated logic circuit in the processor or an instruction in a form of software.

The processor may be a general-purpose processor, a digital signal processor (DSP), an application specific integrated circuit (ASIC), a field programmable gate array (FPGA), or another programmable logic device, a transistor logic device, a hardware component, or any combination thereof. Various methods, steps, and logical block diagrams disclosed in the embodiments of the present disclosure may be implemented or performed. The general-purpose processor may be a microprocessor, or the processor may be any conventional processor, or the like. Steps of the methods disclosed with reference to the embodiments of the present disclosure may be directly performed and completed by a hardware decoding processor, or may be performed and completed by using a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the operations of the foregoing methods in combination with hardware of the processor.

The memory in this embodiment of the present disclosure may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of exemplary but not limited description, RAM in many forms is available, for example, a static RAM (SRAM), a dynamic RAM (DRAM), a synchronous DRAM (SDRAM), a double data rate SDRAM (DDR SDRAM), an enhanced SDRAM (ESDRAM), a synchlinkDRAM (SLDRAM), and a direct rambus RAM (DRRAM). The memory in the system and method described in this specification is intended to include but is not limited to these memories and any other suitable type of memory. The foregoing memory is an exemplary but not a restrictive description.

An embodiment of the present disclosure further provides a computer readable storage medium which is configured to store a computer program.

In some embodiments, the computer readable storage medium may be applied to each network element in the embodiments of the present disclosure, and the computer program causes a computer to perform a corresponding process implemented by each network element in each method in the embodiments of the present disclosure. For brevity, details are not described herein again.

In some embodiments, the computer readable storage medium may be applied to a mobile terminal/terminal in this embodiment of the present disclosure, and the computer program causes a computer to perform corresponding processes implemented by the mobile terminal/terminal in the methods in this embodiment of the present disclosure. For brevity, details are not described herein again.

An embodiment of the present disclosure further provides a computer program product, including a computer program instruction.

In some embodiments, the computer program product may be applied to each network element in the embodiments of the present disclosure, and the computer program instruction enables a computer to perform a corresponding process implemented by each network element in each method in the embodiments of the present disclosure. For brevity, details are not described herein again.

In some embodiments, the computer program product may be applied to a mobile terminal/terminal in the embodiments of the present disclosure, and the computer program instruction enables a computer to perform corresponding processes implemented by the mobile terminal/terminal in the methods in the embodiments of the present disclosure. For brevity, details are not described herein again.

An embodiment of the present disclosure further provides a computer program.

In some embodiments, the computer program may be applied to each network element in the embodiments of the present disclosure. When the computer program runs on a computer, the computer causes the computer to perform a corresponding process implemented by each network element in each method in the embodiments of the present disclosure. For brevity, details are not described herein again.

In some embodiments, the computer program may be applied to a mobile terminal/terminal in this embodiment of the present disclosure. When the computer program runs on a computer, the computer causes the computer to perform corresponding processes implemented by the mobile terminal/terminal in the methods in this embodiment of the present disclosure. For brevity, details are not described herein again.

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it is not be considered that the implementation goes beyond the scope of the present disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in the present disclosure, the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed.

The foregoing units described as separate parts may or may not be physically separate, and parts displayed as units may or may not be physical units, may be located in one position, or may be distributed on a plurality of network units. Some or all of the units may be selected according to actual requirements to achieve the objectives of the solutions of embodiments.

In addition, functional units in the embodiments of the present disclosure may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the current technology, or some of the technical solutions may be implemented in a form of a software product. The computer software product is stored in a storage medium, and includes several instructions for indicating a computing device (which may be a personal computer, a server, a network device, or the like) to perform all or a part of the steps of the methods described in embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A data packet transmission method performed by a user plane function, the method comprising:
receiving a data packet;
determining storage time information of the data packet;
transmitting the data packet and the storage time information of the data packet to a storage function network element;
indicating the storage function network element to store the data packet and the storage time information of the data packet;
determining a transmitting time of the data packet according to the storage time information; and
transmitting the data packet to a destination outside the storage function network element at the transmitting time.

2. The data packet transmission method according to claim 1, wherein the data packet comprises an uplink data packet; and
the receiving a data packet comprises:
receiving the uplink data packet from a session management function.

3. The data packet transmission method according to claim 2, wherein the determining storage time information of the data packet comprises:
receiving storage time information of the uplink data packet from the session management function.

4. The data packet transmission method according to claim 2, wherein the determining storage time information of the data packet comprises:
receiving a time parameter of the data packet from the session management function, the time parameter comprising a latest arrival time and/or a maximum value of a transmission delay that are/is of the data packet; and
determining storage time information of the uplink data packet according to the time parameter of the data packet.

5. The data packet transmission method according to claim 1, wherein the data packet comprises an uplink data packet; and
the receiving a data packet comprises:
receiving the uplink data packet from a base station.

6. The data packet transmission method according to claim 5, wherein the base station is any one of (i) a base station having a new radio satellite access technology, (ii) a base station deployed on a satellite, and (iii) a base station using a satellite link as a backhaul.

7. The data packet transmission method according to claim 5, wherein the determining storage time information of the data packet comprises:
receiving a time parameter of the data packet from a session management function in a protocol data unit session establishment or update procedure, the time parameter comprising a latest arrival time and/or a maximum value of a transmission delay that are/is of the data packet; and
determining storage time information of the uplink data packet according to the time parameter of the data packet.

8. The data packet transmission method according to claim 7, wherein the determining storage time information of the uplink data packet according to the time parameter of the data packet comprises:
receiving current satellite access type information from the session management function; and
determining the storage time information of the uplink data packet according to the current satellite access type information and the time parameter.

9. The data packet transmission method according to claim 5, wherein the determining storage time information of the data packet comprises:
receiving storage time information of the uplink data packet from a session management function in a protocol data unit session establishment or update procedure.

10. The data packet transmission method according to claim 5, wherein the uplink data packet carries a time parameter; and
the determining storage time information of the data packet comprises:
determining storage time information of the uplink data packet according to the time parameter carried in the uplink data packet.

11. The data packet transmission method according to claim 1, wherein the determining storage time information of the data packet comprises:
directly or indirectly obtaining a time parameter of a data packet and data packet identification information from an application function;
determining the time parameter of the data packet as the time parameter of the data packet if the data packet matches the data packet identification information, the time parameter comprising a latest arrival time and/or a maximum value of a transmission delay that are/is of the data packet; and
determining the storage time information of the data packet according to the time parameter of the data packet.

12. The data packet transmission method according to claim 1, wherein the determining storage time information of the data packet, and transmitting the data packet and the storage time information of the data packet to a storage function network element comprises:
receiving indication information;
determining, according to the indication information, whether to determine the storage time information of the data packet; and
transmitting the data packet and the storage time information of the data packet to the storage function network element.

13. A communication device, comprising:
at least one memory configured to store program code; and
at least one processor configured to read the program code and operate as instructed by the program code, the program code comprising:
a first receiving code configured to cause the at least one of the at least one processor to receive a data packet;
a first determining code configured to cause the at least one of the at least one processor to determine storage time information of the data packet;
a first transmitting code configured to cause the at least one of the at least one processor to transmit the data packet and the storage time information of the data packet to a storage function network element;
an indicating code configured to cause the at least one of the at least one processor to indicate the storage function network element to store the data packet and the storage time information of the data packet;
a second determining code configured to cause the at least one of the at least one processor to determine a transmitting time of the data packet according to the storage time information; and
a second transmitting code configured to cause the at least one of the at least one processor to transmit the data packet to a destination outside the storage function network element at the transmitting time.

14. The communication device according to claim 13, wherein the data packet comprises an uplink data packet; and the first receiving code comprises:
a second receiving code configured to cause the at least one of the at least one processor to receive the uplink data packet from a session management function.

15. The communication device according to claim 14, wherein the first determining code comprises:
a third receiving code configured to cause the at least one of the at least one processor to receive storage time information of the uplink data packet from the session management function.

16. The communication device according to claim 14, wherein the first determining code comprises:
a fourth receiving code configured to cause the at least one of the at least one processor to receive a time parameter of the data packet from the session management function, the time parameter comprising a latest arrival time and/or a maximum value of a transmission delay that are/is of the data packet; and
a third determining code configured to cause the at least one of the at least one processor to determine storage time information of the uplink data packet according to the time parameter of the data packet.

17. A non-transitory computer-readable storage medium, storing computer code which, when executed by at least one processor, causes the at least one processor to at least:
receive a data packet;
determine storage time information of the data packet;
transmit the data packet and the storage time information of the data packet to a storage function network element;
indicate the storage function network element to store the data packet and the storage time information of the data packet;
determine a transmitting time of the data packet according to the storage time information; and
transmit the data packet to a destination outside the storage function network element at the transmitting time.

18. The non-transitory computer-readable storage medium according to claim 17, wherein the data packet comprises an uplink data packet; and
the receiving a data packet comprises:
receiving the uplink data packet from a session management function.

19. The non-transitory computer-readable storage medium according to claim 18, wherein the determining storage time information of the data packet comprises:
receiving storage time information of the uplink data packet from the session management function.

20. The non-transitory computer-readable storage medium according to claim 18, wherein the determining storage time information of the data packet comprises:
receiving a time parameter of the data packet from the session management function, the time parameter comprising a latest arrival time and/or a maximum value of a transmission delay that are/is of the data packet; and
determining storage time information of the uplink data packet according to the time parameter of the data packet.
